(19) United States
(12) Patent Application Publication
(10) Pub. No.: US 2007/0178231 A1
(43) Pub. Date: Aug. 2, 2007

(54) METHOD OF PRODUCING MULTILAYER OPTICAL RECORDING MEDIUM

(75) Inventor: Kyosuke Deguchi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/625,953

(22) Filed: Jan. 23, 2007

(30) Foreign Application Priority Data
Jan. 30, 2006 (JP) 2006-020894
Jan. 10, 2007 (JP) 2007-002336

(51) Int. Cl. B05D 5/06; B05D 3/12; B29D 17/00; B29D 11/00

(52) U.S. Cl. 427/162; 427/355; 264/1.33; 264/1.34; 264/1.36; 264/1.38; 264/1.6; 264/1.7

(57) ABSTRACT

Provided is a method of producing a multilayer optical recording medium, which is capable of producing the recording medium with high accuracy of distances between layers without necessity of disposing stampers, and which includes the steps of (a) forming a resin layer with respect to a support substrate; (b) disposing a stamper on the resin layer and irradiating a light beam thereto through the support substrate or the stamper to transfer an unevenness pattern of the stamper to the resin layer; (c) forming a recording layer on the resin layer; (d) repeating the steps (a) to (c) n times to stack n layers of resin layer with recording layer on the support substrate; (e) bonding a base substrate to the n-th recording layer through an adhesive layer; and (f) peeling off the support substrate.

### BACKGROUND OF THE INVENTION

1. Field of the Invention

The present invention relates to a method of producing a multilayer optical recording medium, and more particularly, to a method of producing a multilayer optical recording medium in which a photoreactive curable resin is applied to a substrate to stack a recording layer by means of spin coating or the like.

2. Description of the Related Art

In recent years, an optical recording medium has been applied as a recording medium for recording or reproducing various information in the field of computers, audio-visuals, and the like. In addition, popularization of mobile computers and diversification of information have been promoted, so that there is a continuing need for an optical recording medium which is reduced in size and is large in capacity.

In the optical recording medium for recording or reproducing information by utilizing light, a fine uneven pattern such as pits or guide grooves for obtaining a tracking servo signal or the like are formed on a substrate. On the fine uneven pattern, a recording layer or a reflective layer is formed. There are two types of optical recording medium, that is, an optical recording medium having a single plate structure in which an organic protective layer is further formed thereon, and an optical recording medium having a structure in which two substrates are bonded such that the recording layers or the reflective layers face each other.

To meet a demand for a higher density of the optical recording medium, there has been proposed a recording medium in which a plurality of recording layers are formed on one surface of a substrate. Specifically, while the recording medium having the single plate structure and the recording medium having the structure in which two substrates are bonded together have only one recording layer on one surface of the substrate, the proposed recording medium has a plurality of recording layers on one surface of the substrate. That is, a recording layer is formed on a support substrate having a signal pattern formed thereon, and a recording layer is further formed on the recording layer through a fine uneven pattern forming layer. The signal pattern forming layer and the recording layer are repeatedly formed as needed, and an organic protective layer (i.e., cover sheet) is formed last on the recording layer, to thereby produce an optical recording medium having a plurality of recording layers on one surface of the substrate. Incidentally, light for recording, reproducing, and erasing information can be made incident not only from the substrate surface side but also from the side of the surface of the organic protective layer formed on the recording layer, and one surface or both surfaces can be used as a light incident plane. However, it is known that the thickness of a light transmissive substrate can be made thin more easily when the light is made incident from the side of the surface of the organic protective layer, whereby it is possible to increase the numerical aperture (NA) of an objective lens of a pickup, which is advantageous in obtaining higher density of the optical recording medium.

The method of forming a plurality of recording layers on one surface of a substrate is proposed in Japanese Patent Application Laid-Open Nos. 2002-260307 and 2003-203402, and Matsushita Technical Journal Vol. 50, No. 5, October 2004, p. 64-68.

However, it has been found that the proposed method has the following problem. Japanese Patent Application Laid-Open No. 2003-203402 and Matsushita Technical Journal Vol. 50, No. 5, October 2004, p. 64-68 propose a method of producing a multilayer optical recording medium in which pits or guide grooves are formed on a surface of a substrate, a reflective layer or a recording layer is formed thereon to form a first information recording layer, and then the following steps are repeated.
(1) An ultraviolet curable resin or a dry photopolymer is formed on the first information recording layer.
(2) A resin stamper is superposed on the ultraviolet curable resin or the dry photopolymer to form pits or guide grooves, and the stamper is peeled off.
(3) A translucent film is formed on the pits or the guide grooves.

In the proposed method, the conventional photopolymer method (so-called 2P method) is applied, so that it is considered that the positional accuracy of the respective layers can be controlled relatively easily, and a high-quality recording medium can be obtained. However, it is necessary to use a transparent stamper and to irradiate an ultraviolet ray from the stamper side. As the transparent stamper, it is considered to use a stamper made of a resin, but it is difficult to reuse the stamper made of a resin in terms of productivity and product quality. Thus, the stamper is disposed after formation of each layer, so that there is posed a problem that the production cost are increased. When the stamper made of a resin is used, the thickness or flatness of the stamper itself varies in one stamper or among stampers, which makes it difficult to control the accuracy of distances between layers.

Accordingly, the conventional method of producing a multilayer optical recording medium having four layers of information recording surfaces, that is, L0 layer to L3 layer will be described with reference to FIGS. 4A to 4D. FIGS. 4A to 4D each show a cross-sectional view of a rotationally symmetric disk having a center hole with the center hole of each of the substrate and the stamper being not shown.

In (1) of FIG. 4A, a PC substrate 15 (base substrate) is made of a polycarbonate subjected to injection molding using a stamper 22 for injection molding, and pits or guide grooves each having a depth of about several tens of nm are formed on the PC substrate 15 as an information pattern 16 for the L0 layer. Typically, the PC substrate 15 has a thickness of 1.1 mm, a diameter of 120 mm, and a center hole diameter of 15 mm.

In (2) of FIG. 4A, on the information pattern 16 for the L0 layer, an L0 layer recording film 17 is formed. The L0 layer recording film 17 typically includes a reflective film which does not transmit light.

In (3) of FIG. 4A, an intermediate layer-3 forming 2p resin 18 for constituting an intermediate layer-3 to be provided on the L0 layer between the L0 layer and the L1 layer is applied to the L0 layer recording film 17. The thickness of the intermediate layer-3 forming 2p resin 18 is, for example, 10 μm. For the sake of simplicity, the intermediate layer-3 forming 2p resin 18 is depicted as a single layer, but a combination of a plurality of layers of different resins may be used therefor in order to satisfy desired transfer property, peeling property, and thickness accuracy.

In (4) of FIG. 4A, on the intermediate layer-3 forming 2p resin 18, a transparent stamper a 19-1 made of a resin having an information pattern for the L1 layer formed thereon in advance is aligned using a center hole (not shown) and superposed thereon. After that, an ultraviolet ray from an UV light source 5 is irradiated thereon through the transparent stamper a 19-1 to cure the intermediate layer-3 forming 2p resin 18. The intermediate layer-3 forming 2p resin 18 may be superposed on the L0 layer recording film 17 on the PC substrate 15 after being applied to the transparent stamper a 19-1.

In (5) of FIG. 4A, after the intermediate layer-3 forming 2p resin 18 has been cured, when the transparent stamper a 19-1 is peeled off, pits or guide grooves each having a depth of about several tens of nm are formed on the PC substrate 15 as an information pattern 13 for the L1 layer. The thus peeled off transparent stamper a 19-1 is degraded due to the irradiation with the ultraviolet ray and cannot therefore be reused as a stamper, and in addition, application thereof is limited even when reused.

In (6) of FIG. 4B, an L1 layer recording film 14 is formed on the information pattern 13 for the L1 layer. The L1 layer recording film 14 is formed of a translucent film.

In (7) of FIG. 4B, an intermediate layer-2 forming 2p resin 11 for constituting an intermediate layer-2 to be provided on the L1 layer between the L1 layer and the L2 layer is applied to the L1 layer recording film 14 in the same manner as described above. The thickness of the intermediate layer-2 forming 2p resin 11 is, for example, 15 μm.

In (8) of FIG. 4B, on the intermediate layer-2 forming 2p resin 11, a transparent stamper b 19-2 made of a resin having an information pattern for the L2 layer formed thereon in advance is aligned using a center hole (not shown) and superposed thereon. After that, an ultraviolet ray from the UV light source 5 is irradiated thereon through the transparent stamper b 19-2 in the same manner as described above to cure the intermediate layer-2 forming 2p resin 11.

In (9) of FIG. 4B, after the intermediate layer-2 forming 2p resin 11 has been cured, when the transparent stamper b 19-2 is peeled off, pits or guide grooves each having a depth of about several tens of nm are formed on the PC substrate 15 as an information pattern 9 for the L2 layer. The thus peeled off transparent stamper b 19-2 is degraded due to the irradiation with the ultraviolet ray cannot therefore be reused as a stamper, as is the case with the above.

In (10) of FIG. 4B, on the information pattern 9 for the L2 layer, an L2 layer recording film 10 is formed. The L2 layer recording film 10 is formed of a translucent film, as is the case with the above.

In (11) of FIG. 4C, an intermediate layer-1 forming 2p resin 7 for constituting an intermediate layer-1 to be provided on the L2 layer between the L2 layer and the L3 layer is applied to the L2 layer recording film 10 in the same manner as described above. The thickness of the intermediate layer-1 forming 2p resin 7 is 10 μm.

In (12) of FIG. 4C, on the intermediate layer-1 forming 2p resin 7, a transparent stamper c 19-3 made of a resin having an information pattern for the L3 layer formed thereon in advance is aligned using a center hole (not shown) and superposed thereon. After that, an ultraviolet ray from the UV light source 5 is irradiated thereon through the transparent stamper c 19-3 in the same manner as described above to cure the intermediate layer-1 forming 2p resin 7.

In (13) of FIG. 4C, after the intermediate layer-1 forming 2p resin 7 has been cured, when the transparent stamper c 19-3 is peeled off, pits or guide grooves each having a depth of about several tens of nm are formed on the PC substrate 15 as information pattern 4 for the L3 layer. As is the case with the above, the thus peeled off transparent stamper c 19-3 is degraded due to the irradiation with the ultraviolet ray and cannot therefore be reused as a stamper.

In (14) of FIG. 4C, an L3 layer recording film 6 is formed on the information pattern 4 for the L3 layer. The L3 layer recording film 6 is formed of a translucent film.

In (15) of FIG. 4D, a cover sheet 2p resin 2 for constituting a cover sheet on the L3 layer recording film 6 is applied in the same manner as described above. The thickness of the cover sheet 2p resin 2 is, for example, 70 μm.

In (16) of FIG. 4D, an ultraviolet ray from the UV light source 5 is irradiated thereon to cure the cover sheet 2p resin 2. Instead of application and curing of the cover sheet 2p resin 2, a resin sheet having a thickness of 70 μm may be bonded.

As described above, the stamper used in the above proposed method is degraded due to the irradiation with the ultraviolet ray and cannot be reused as a stamper. In addition, since the resin substrate or the resin stamper is used, it is difficult to produce a recording medium with high accuracy of distances between layers.

Thus, in the conventional method, the transparent stampers a, b, and c made of a resin are used. However, because it is difficult to reuse the stampers in terms of productivity and product quality, the stampers are disposed after formation of each layer, which poses a problem that the production cost is remarkably increased. In particular, as the number of layers is increased, the problem of the increase in the cost due to the disposal of the stamper made of a resin becomes more serious. In addition, when the resin substrate is used, there arises a problem that a film thickness error is increased by the influence of an error of substrate thickness or flatness of substrate surface.

### SUMMARY OF THE INVENTION

It is, therefore, an object of the present invention to provide a method of producing a multilayer optical recording medium, which is capable of producing the multilayer optical recording medium with high accuracy of distances between layers, without the necessity of disposing stampers.

In particular, in order to solve the above-mentioned problems, there is provided a method of producing a multilayer optical recording medium which comprises n (an integer of 2 or more) recording layers on a base substrate, the method comprising the steps of:

(a) forming a resin layer with respect to a support substrate;

(b) disposing a stamper on the resin layer and irradiating a light beam thereto through the support substrate or the stamper to transfer an unevenness pattern of the stamper to the resin layer;

(c) forming a recording layer on the resin layer;

(d) repeating the steps (a) to (c) n times to stack n layers of resin layer with recording layer on the support substrate;

(e) bonding a base substrate to the n-th recording layer through an adhesive layer; and

(f) peeling off the support substrate.

In the present invention, it is effective that at least one of the support substrate and the stamper transmits light beam.

Further, it is effective that the support substrate comprises glass or transparent ceramics as a main material and the stamper comprises metal as a main material.

Moreover, it is effective that the support substrate comprises metal as a main material, and the stamper comprises glass or transparent ceramics as a main material.

In addition, it is effective that the support substrate and the stamper each comprise glass or ceramics as a main material.

Incidentally, examples of the multilayer optical recording medium according to the present invention include a multilayer optical disk, a multilayer optical card, and a multilayer optical tape.

Further features of the present invention will become apparent from the following description of exemplary embodiments with reference to the attached drawings.

### BRIEF DESCRIPTION OF THE DRAWINGS

FIG. 1A is a cross-sectional view for illustrating steps (1) to (6) of a method of producing a four-layered recording medium according to a first embodiment of the present invention.

FIG. 1B is a cross-sectional view for illustrating steps (7) to (11) of the method of producing the four-layered recording medium according to the first embodiment of the present invention.

FIG. 1C is a cross-sectional view for illustrating steps (12) to (15) of the method of producing the four-layered recording medium according to the first embodiment of the present invention.

FIG. 1D is a cross-sectional view for illustrating steps (16) to (19) of the method of producing the four-layered recording medium according to the first embodiment of the present invention.

FIG. 2 is a cross-sectional view for illustrating the structure of a four-layered recording medium according to the present invention.

FIG. 3A is a cross-sectional view for illustrating steps (1) to (6) of a method of producing a four-layered recording medium according to a second embodiment of the present invention.

FIG. 3B is a cross-sectional view for illustrating steps (7) to (11) of the method of producing the four-layered recording medium according to the second embodiment of the present invention.

FIG. 3C is a cross-sectional view for illustrating steps (12) to (15) of the method of producing the four-layered recording medium according to the second embodiment of the present invention.

FIG. 3D is a cross-sectional view for illustrating steps (16) to (19) of the method of producing the four-layered recording medium according to the second embodiment of the present invention.

FIG. 4A is a cross-sectional view for illustrating steps (1) to (5) of a conventional method of producing a four-layered recording medium.

FIG. 4B is a cross-sectional view for illustrating steps (6) to (10) of the conventional method of producing the conventional four-layered recording medium.

FIG. 4C is a cross-sectional view for illustrating steps (11) to (14) of the conventional method of producing the conventional four-layered recording medium.

FIG. 4D is a cross-sectional view for illustrating steps (15) and (16) of the conventional method of producing the conventional four-layered recording medium.

### DESCRIPTION OF THE EMBODIMENTS

Hereinafter, embodiments of the present invention will be described in detail with reference to the drawings.

### EXAMPLE 1

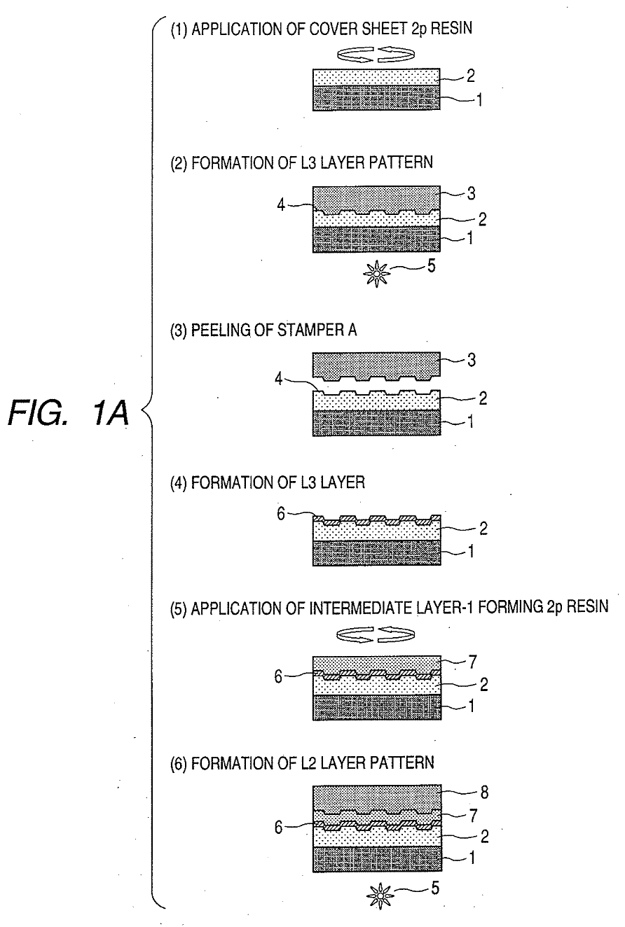

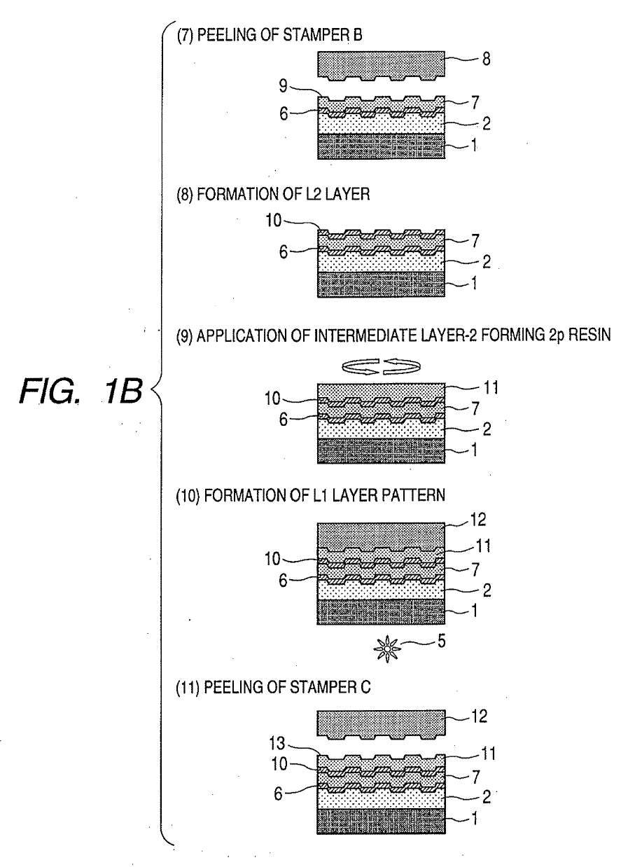

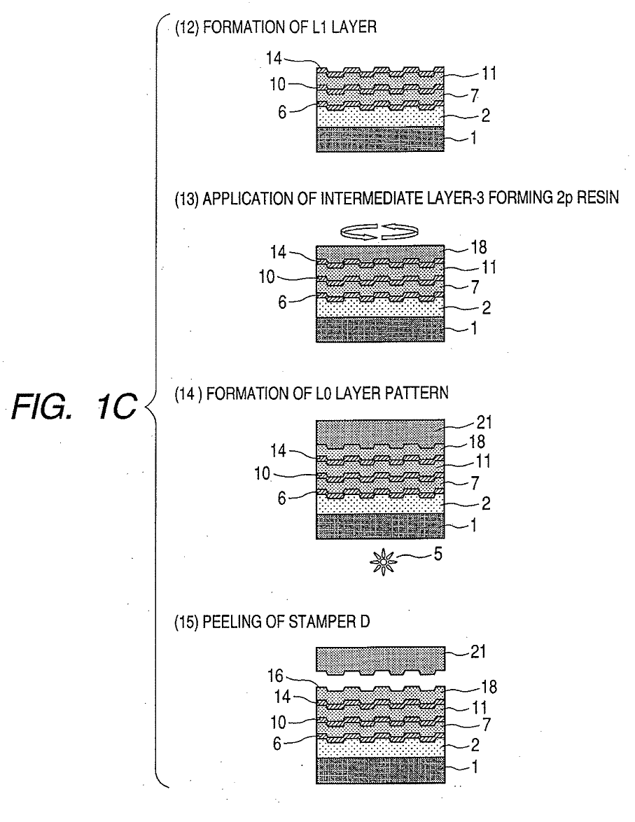

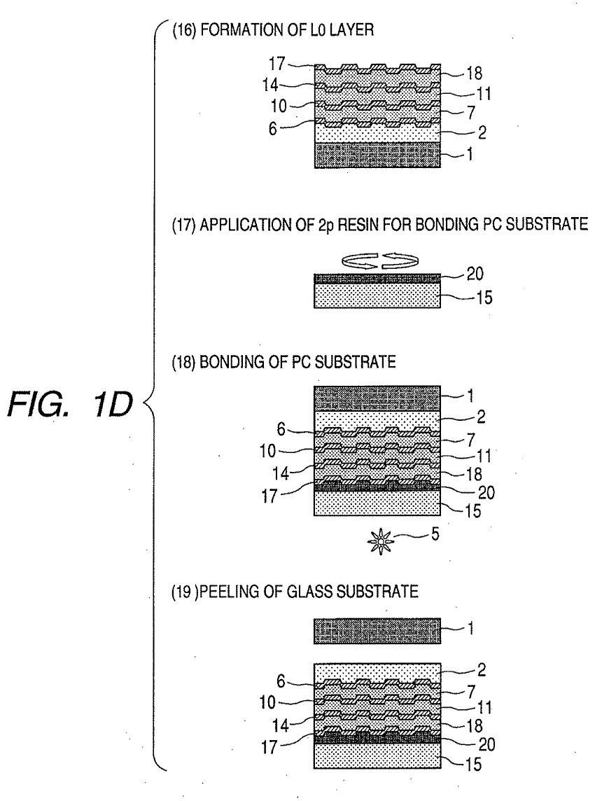

A method of producing a four-layered optical recording medium according to a first example of the present invention will be described with reference to FIGS. 1A to 1D. FIGS. 1A to 1D each show four layers of information recording surfaces, that is, an L0 layer, an L1 layer, an L2 layer, and an L3 layer. FIGS. 1A to 1D are each a cross-sectional view of a rotationally symmetric disk having a center hole, and a center hole of each of a substrate and a stamper is not shown. Like elements in the respective FIGURES have the same reference numerals.

In (1) of FIG. 1A, a cover sheet 2p resin (i.e., photoreactive curable resin) 2 for constituting a cover sheet (i.e., resin protective layer) provided on an L3 layer recording film is applied to a glass substrate (i.e., support substrate) 1. The glass substrate 1 preferably has a thickness of 0.5 to 10 mm, a diameter of 80 to 120 mm, and a center hole diameter of 10 to 15 mm. Typically, the glass substrate 1 has a thickness of 1 mm, and a diameter and a center hole diameter, which are substantially the same as those of a PC substrate, of, for example, 120 mm and 15 mm, respectively. The cover sheet 2p resin 2 is dropped in an annular manner on an inner periphery side of the glass substrate 1 having a center hole (not shown), and the glass substrate 1 is rotated to remove droplets, thereby obtaining a uniform thickness (first constant thickness). As the support substrate, a transparent ceramic substrate or the like is preferably used besides a transparent glass substrate. For the cover sheet 2p resin 2, it is possible to appropriately select a resin from among resins which are curable by irradiation with an ultraviolet ray (or visible light) to be performed later. The thickness of the cover sheet 2p resin 2 is preferably 40 to 100 μm, and is, for example, 70 μm.

In (2) of FIG. 1A, on the cover sheet 2p resin 2, a stamper A (first stamper) 3 mainly made of a metal having an information pattern for the L3 layer (first pattern) formed thereon in advance is aligned with the glass substrate 1 using a center hole (not shown) and superposed thereon. After that, an ultraviolet ray from an UV light source 5 is irradiated thereon through the glass substrate 1 to cure the cover sheet 2p resin 2. The cover sheet 2p resin 2 may be superposed on the glass substrate 1 after being applied to the stamper A 3. For the sake of simplicity, the cover sheet 2p resin 2 is depicted as a single layer, but a combination of a plurality of layers of different resins may be used therefor in order to satisfy desired transfer property, peeling property, and thickness accuracy. The stamper A 3 is preferably made of, for example, nickel. The stamper A 3 preferably has a thickness of 0.2 to 2 mm, a diameter of 80 to 120 mm, and a center hole diameter of 10 to 15 mm. Typically, the stamper A 3 has the thickness of 0.3 mm, and a diameter and a center hole diameter, which are substantially the same as those of a PC substrate, of, for example, 120 mm and 15 mm, respectively.

In (3) of FIG. 1A, after the cover sheet 2p resin 2 has been cured, when the stamper A 3 is peeled off, pits or guide grooves each having a depth of several tens of nm are formed on the glass substrate 1 as an information pattern 4 for the L3 layer. The thus peeled off stamper A made of a metal will not be degraded even when irradiated with an UV light flux, and can be repeatedly used.

In (4) of FIG. 1A, an L3 layer recording film 6 is formed on the information pattern 4 for the L3 layer. The L3 layer recording film 6 is formed of a translucent film.

In (5) of FIG. 1A, onto the L3 layer recording film 6, an intermediate layer-1 forming 2p resin 7 for constituting an intermediate layer-1 between the L3 layer and the L2 layer provided under the L3 layer is applied. The intermediate layer-1 forming 2p resin 7 is dropped in an annular manner on the inner periphery side of the glass substrate 1 having a center hole (not shown), and the glass substrate 1 is rotated to remove droplets, thereby obtaining a uniform thickness (second constant thickness). For the intermediate layer-1 forming 2p resin 7, it is possible to appropriately select a resin from among resins which are curable by irradiation with an ultraviolet ray (or visible light) to be performed later. The thickness of the intermediate layer-1 forming 2p resin 7 of this case is 10 μm.

In (6) of FIG. 1A, on the intermediate layer-1 forming 2p resin 7, a stamper B (second stamper) 8 made of a metal having an information pattern for the L2 layer (second pattern) formed thereon in advance is aligned with the glass substrate 1 using a center hole (not shown) to be superposed thereon. After that, an ultraviolet ray from the UV light source 5 is irradiated thereto through the glass substrate 1 to cure the intermediate layer-1 forming 2p resin 7. At this time, the L3 recording film 6 needs to be translucent at the wavelength of the UV light flux and has a transmittance of 20% or more. Incidentally, when, in order to obtain a transmittance of 50% or more of the L3 recording film 6, a visible light source is used instead of the UV light source and a resin which is curable at the wavelength of the visible light flux is selected, it is possible to shorten the time for curing the resin. The intermediate layer-1 forming 2p resin 7 may be superposed on the glass substrate 1 after being applied to the stamper B 8. For the sake of simplicity, the intermediate layer-1 forming 2p resin 7 is depicted as a single layer, but a combination of a plurality of layers of different resins may be used therefor in order to satisfy the desired transfer property, peeling property, and thickness accuracy. The stamper B 8 is preferably made of, for example, nickel. The stamper B 8 preferably has a thickness of 0.2 to 2 mm, a diameter of 80 to 120 mm, and a center hole diameter of 10 to 15 mm. Typically, the stamper B 8 has a thickness of 0.3 mm, and a diameter and a center hole diameter, which are substantially the same as those of a PC substrate, of, for example, 120 mm and 15 mm, respectively.

In (7) of FIG. 1B, after the intermediate layer-1 forming 2p resin 7 has been cured, when the stamper B 8 is peeled off, pits or guide grooves each having a depth of several tens of nm are formed on the L3 layer recording film 6 as an information pattern 9 for the L2 layer. The thus peeled off stamper B made of a metal will not be degraded even when irradiated with an UV light flux, and can be repeatedly used.

In (8) of FIG. 1B, on the information pattern 9 for the L2 layer, an L2 layer recording film 10 is formed. The L2 layer recording film 10 is formed of a translucent film.

In (9) of FIG. 1B, onto the L2 layer recording film 10, an intermediate layer-2 forming 2p resin 11 for constituting an intermediate layer-2 between the L2 layer and the L1 layer provided under the L2 layer is applied. The intermediate layer-2 forming 2p resin 11 is dropped in an annular manner on the inner periphery side of the glass substrate 1 having a center hole (not shown), and the glass substrate 1 is rotated to remove droplets, thereby obtaining a uniform thickness (third constant thickness). For the intermediate layer-2 forming 2p resin 11, it is possible to appropriately select a resin from among resins which are curable by irradiation with an ultraviolet ray (or visible light) to be performed later. The thickness of the intermediate layer-2 forming 2p resin 11 of this case is 150 μm.

In (10) of FIG. 1B, on the intermediate layer-2 forming 2p resin 11, a stamper C (third stamper) 12 made of a metal having an information pattern for the L1 layer (third pattern) formed thereon in advance is aligned with the glass substrate 1 using a center hole and superposed thereon. After that, an ultraviolet ray from the UV light source 5 is irradiated thereto through the glass substrate 1 to cure the intermediate layer-2 forming 2p resin 11. At this time, the L3 recording film 6 and the L2 recording film 10 need to be translucent at the wavelength of the UV light flux, and preferably have a transmittance of 20% or more in their entirety. When, in order to obtain a transmittance of 50% or more of the L3 recording film 6 and the L2 recording film 10 in their entirety, a visible light source is used instead of the UV light source and a resin which is curable at the wavelength of the visible light flux, it is possible to shorten the time for curing the resin. The intermediate layer-2 forming 2p resin 11 may be superposed on the glass substrate 1 after being applied to the stamper C 12. For the sake of simplicity, the intermediate layer-2 forming 2p resin 11 is depicted as a single layer, but a combination of a plurality of layers of different resins may be used therefor in order to satisfy the desired transfer property, peeling property, and thickness accuracy. The stamper C 12 is preferably made of, for example, nickel. The stamper C 12 preferably has a thickness of 0.2 to 2 mm, a diameter of 80 to 120 mm, and a center hole diameter of 10 to 15 mm. Typically, the stamper C 12 has a thickness of 0.3 mm, and a diameter and a center hole diameter, which are substantially the same as those of a PC substrate, of, for example, 120 mm and 15 mm, respectively.

In (11) of FIG. 1B, after the intermediate layer-2 forming 2p resin 11 has been cured, when the stamper C 12 is peeled off, pits or guide grooves each having a depth of several tens of nm are formed on the L2 layer recording film 10 as an information pattern 13 for the L1 layer. The thus peeled off stamper C made of a metal will not be degraded even when irradiated with an UV light flux, and can be repeatedly used.

In (12) of FIG. 1C, on the information pattern 13 for the L1 layer, an L1 layer recording film 14 is formed. The L1 layer recording film 14 is formed of a translucent film.

In (13) of FIG. 1C, onto the L1 layer recording film 14, an intermediate layer-3 forming 2p resin 18 for constituting an intermediate layer-3 between the L1 layer and the L0 layer provided under the L1 layer is applied. The intermediate layer-3 forming 2p resin 18 is dropped in an annular manner on the inner periphery side of the glass substrate 1 having a center hole (not shown), and the glass substrate 1 is rotated to remove droplets, thereby obtaining a uniform thickness (fourth constant thickness). For the intermediate layer-3 forming 2p resin 18, it is possible to appropriately select a resin from among resins which are curable by irradiation with an ultraviolet ray (or visible light) to be performed later. The thickness of the intermediate layer-3 forming 2p resin 18 of this case is 10 μm.

In (14) of FIG. 1C, on the intermediate layer-3 forming 2p resin 18, a stamper D (fourth stamper) 21 made of a metal having an information pattern for the L0 layer (fourth pattern) formed thereon in advance is aligned with the glass substrate 1 using a center hole and superposed thereon. After that, an ultraviolet ray from the UV light source 5 is irradiated thereon through the glass substrate 1 to cure the intermediate layer-3 forming 2p resin 18. In this case, the L3 recording film 6, the L2 recording film 10, and L1 layer recording film 14 need to be translucent at the wavelength of the UV light flux, and preferably have a transmittance of 20% or more in their entirety. When, in order to obtain a transmittance of 50% or more of the L3 recording film 6, the L2 recording film 10, and L1 layer recording film 14 in their entirety, a visible light source is used instead of the UV light source and a resin which is curable at the wavelength of the visible light flux, it is possible to shorten the time for curing the resin. The intermediate layer-3 forming 2p resin 18 may be superposed on the glass substrate 1 after being applied to the stamper D 21. For the sake of simplicity, the intermediate layer-3 forming 2p resin 18 is depicted as a single layer, but a combination of a plurality of layers of different resins may be used therefor in order to satisfy the desired transfer property, peeling property, and thickness accuracy. The stamper D 21 is preferably made of, for example, nickel. The stamper D 21 preferably has a thickness of 0.2 to 2 mm, a diameter of 80 to 120 mm, and a center hole diameter of 10 to 15 mm. Typically, the stamper D 21 has a thickness of 0.3 mm, and a diameter and a center hole diameter, which are substantially the same as those of a PC substrate, of, for example, 120 mm and 15 mm, respectively.

In (15) of FIG. 1C, after the intermediate layer-3 forming 2p resin 18 has been cured, when the stamper D 21 is peeled off, pits or guide grooves each having a depth of several tens of nm are formed on the L1 layer recording film 14 as an information pattern 16 for the L0 layer. The thus peeled off stamper D made of a metal will not be degraded even when irradiated with an UV light flux, and can be repeatedly used.

The materials of the support substrate and the stamper are just base materials, and the patterns or the like on surfaces may be constituted of materials different from the base materials.

In (16) of FIG. 1D, on the information pattern 16 for the L0 layer, an L0 layer recording film 17 is formed. The L0 layer recording film 17 typically includes a reflective layer which does not transmit light.

In (17) of FIG. 1D, a PC substrate (base substrate) 15 is made of polycarbonate (PC) subjected to injection molding, and no information pattern (pits or guide grooves) is not formed on the substrate. The PC substrate 15 preferably has a thickness of 0.6 to 1.1 mm, a diameter of 80 to 120 mm, and a center hole diameter of 10 to 15 mm. Typically, the PC substrate 15 has a thickness of 1.1 mm, a diameter of 120 mm, and a center hole diameter of 15 mm. Instead of the PC substrate 15, a resin material such as APO (amorphous polyolefin) may be used. On the PC substrate 15, an adhesive layer forming 2p resin 20 is applied for adhesion with the L0 layer. The adhesive layer forming 2p resin 20 is dropped in an annular manner on an inner periphery side of the PC substrate 15 having a center hole (not shown), and the PC substrate 15 is rotated to remove droplets, thereby obtaining a uniform thickness (fifth constant thickness). For the adhesive layer forming 2p resin 20, it is possible to appropriately select a resin from among resins which can bond the PC substrate 15 and the L0 layer recording film 17 and are curable by irradiation with an ultraviolet ray to be performed later. The thickness of the adhesive layer forming 2p resin 20 is, for example, 10 μm. For the sake of simplicity, the adhesive layer forming 2p resin 20 for bonding the PC substrate is depicted as a single layer, but a combination of a plurality of layers of different resins may be used therefor in order to satisfy the desired transfer property, peeling property, and thickness accuracy.

In (18) of FIG. 1D, on the adhesive layer forming 2p resin 20, the glass substrate 1 obtained after completing the step of (16) of FIG. 1D is aligned using a center hole (not shown) and superposed thereon. After that, an ultraviolet ray from the UV light source 5 is irradiated thereon through the PC substrate 15 to cure the adhesive layer forming 2p resin 20 for bonding the PC substrate. The adhesive layer forming 2p resin 20 for bonding the PC substrate may be superposed on the PC substrate 15 after being applied to the L0 layer recording film 17.

In (19) of FIG. 1D, after the adhesive layer forming 2p resin 20 for bonding the PC substrate has been cured, the glass substrate 1 is peeled off, thereby completing the four-layered optical recording medium according to the present invention.

FIG. 1D also shows in (19) thereof a cross-sectional view of the completed four-layered optical recording medium according to the present invention. On the PC substrate 15, four layers of recordings layer (i.e., L0, L1, L2, and L3 layers) are respectively disposed through the adhesive layer and the intermediate layer from the PC substrate side, and a cover layer 2 covers the L3 layer. A light flux for recording/reproduction is made incident on the medium from the cover layer 2 side.

As described with reference to (4) of FIG. 1A, (8) of FIG. 1B, (12) of FIG. 1C, and (16) of FIG. 1D, on the information patterns 4, 9, 13, and 16 of the L3, L2, L1, and L0 layer recording films 6, 10, 14, and 17 of the L3, L2, L1, and L0 layer are formed, respectively. Those films are formed in the following manner. First, on each of the information patterns 4, 9, 13, and 16 of the L3, L2, L1, and L0 layers having guide grooves or pits formed therein, a dielectric layer is formed. Further, there are sequentially formed thereon an interfacial layer and a recording layer as needed, an interfacial layer and a reflective layer as needed, and a high refractive index layer as needed. In other words, on an information pattern, a dielectric layer, a recording layer, and a reflective layer are formed in the mentioned order. Further, as needed, a dielectric layer may be provided between the recording film and the reflective layer.

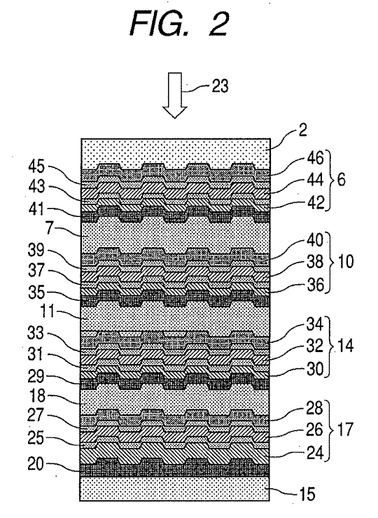

Next, with reference to FIG. 2, the structure of each of the recording films 17, 14, 10, and 6 of the L0 to L3 layers will be described in detail. FIG. 2 is a cross-sectional view of the completed four-layered optical recording medium according to the present invention. On the PC substrate 15, four recording layers, that is, the L0 layer 17, the L1 layer 14, the L2 layer 10, and the L3 layer 6 are disposed through the adhesive layer 20 and the intermediate layers 18, 11, and 7, respectively, and the cover layer 2 covers the L3 layer. A light flux for recording/reproduction is made incident on the medium in a direction (light flux incident direction) indicated by an arrow 23.

The recording films 17, 14, 10, and 6 of each of the L0 to L3 layers will be described by taking a recording film of a recording type as an example. Each of the recording films may be of write-once type or rewritable type, or a reflective film for a ROM, or may be a combination thereof.

In (4) of FIG. 1A, on the information pattern 4 for the L3 layer, the L3 layer recording film 6 is formed by the following procedure. First, on the information pattern 4 for the L3 layer having guide grooves or pits formed therein, an L3 dielectric layer 46 is formed. Further, there are sequentially formed thereon an L3 interfacial layer 45 and an L3 recording layer 44 as needed, an L3 interfacial layer 43 and an L3 reflective layer 42 as needed, and an L3 high refractive index layer 41 as needed. In other words, on the information pattern, the dielectric layer, the recording layer, and the reflective layer are formed in the mentioned order.

Similarly, in (8) of FIG. 1B, on the information pattern 9 for the L2 layer, the L2 layer recording film 10 is formed by the following procedure. First, on the information pattern 9 for the L2 layer having guide grooves or pits formed therein, an L2 dielectric layer 40 is formed. Further, there are sequentially formed thereon an L2 interfacial layer 39 and an L2 recording layer 38 as needed, an L2 interfacial layer 37 and an L2 reflective layer 36 as needed, and an L2 high refractive index layer 35 as needed. In other words, on the information pattern, the dielectric layer, the recording layer, and the reflective layer are formed in the mentioned order.

Similarly, in (12) of FIG. 1C, on the information pattern 13 for the L1 layer, the L1 layer recording film 14 is formed by the following procedure. First, on the information pattern 13 for the L1 layer having guide grooves or pits formed therein, an L1 dielectric layer 34 is formed. Further, there are sequentially formed thereon an L1 interfacial layer 33 and an L1 recording layer 32 as needed, an L1 interfacial layer 31 and an L1 reflective layer 30 as needed, and an L1 high refractive index layer 29 as needed. In other words, on the information pattern, the dielectric layer, the recording layer, and the reflective layer are formed in the mentioned order.

Similarly, in (16) of FIG. 1D, on the information pattern 16 for the L0 layer, the L0 layer recording film 17 is formed by the following procedure. First, on the information pattern 16 for the L0 layer having guide grooves or pits formed therein, an L0 dielectric layer 28 is formed. Further, there are sequentially formed thereon an L0 interfacial layer 27 and an L0 recording layer 26 as needed, and an L0 interfacial layer 25 and an L0 reflective layer 24 as needed. In other words, on the information pattern, the dielectric layer, the recording layer, and the reflective layer are formed in the mentioned order.

In a conventional two-layered optical recording medium, any layer is formed in the order of a reflective layer, a recording layer, and a dielectric layer.

By employing the method of producing a multilayer optical recording medium according to the present invention, it becomes possible to supply a four-layered optical recording medium at low cost without utilizing a transparent stamper which is a factor for increasing the production cost because of the difficulty of reuse.

The respective distances between layers of the four-layered optical recording medium produced by the above-mentioned steps were as follows:
L0 layer-L1 layer: within a range of 10 μm±2 μm;
L1 layer-L2 layer: within a range of 15 μm±2.5 μm; and
L2 layer-L3 layer: within a range of 10 μm±2 μm.

### EXAMPLE 2

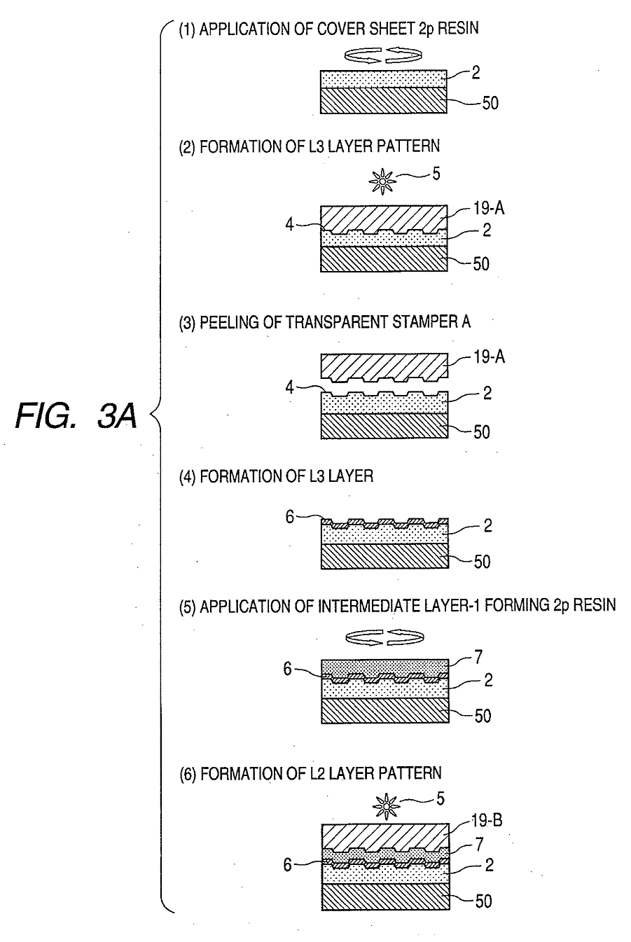

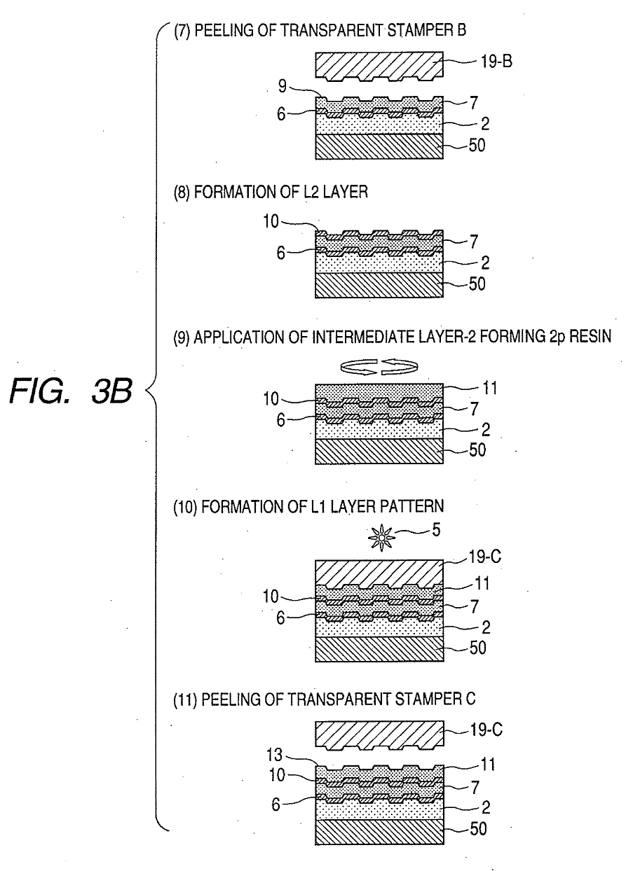

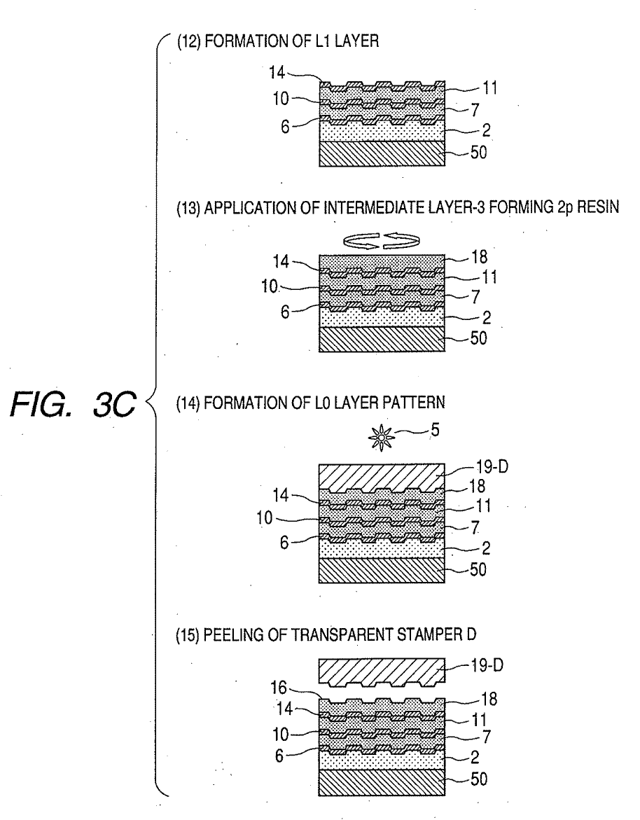

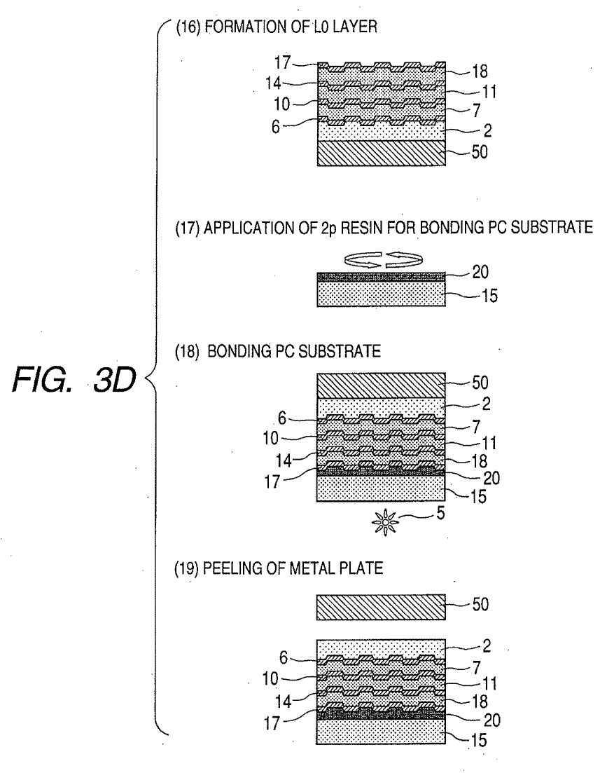

A method of producing a four-layered optical recording medium according to a second example of the present invention will be described with reference to FIGS. 3A to 3D. FIGS. 3A to 3D each show four layers of information recording surface, that is, an L0 layer, an L1 layer, an L2 layer, and an L3 layer. FIGS. 3A to 3D each show a cross-sectional view of a rotationally symmetric disk having a center hole, and the center hole of each of the substrate and the stamper is not shown. In FIGS. 3A to 3D, the elements which are the same as those shown in FIGS. 1A to 1D are identified by like numerals or symbols.

The second example is different from the first example of the present invention in that the support substrate is made of a metal, and transparent stampers A to D (19-A to 19-D) made of glass are used instead of the stampers A to D (3, 8, 12, and 21). Incidentally, it is also preferable that the material of the stampers is made of transparent ceramics. A metal plate 50 is preferably made of, for example, nickel or stainless steel. The metal plate 50 preferably has a thickness of 0.2 to 2 mm, a diameter of 80 to 120 mm, and a center hole diameter of 10 to 15 mm. Typically, the metal plate 50 has a thickness of 0.3 mm, and a diameter and a center hole diameter, which are substantially the same as those of a PC substrate, of, for example, 120 mm and 15 mm, respectively. The transparent stampers A to D (19-A to 19-D) made of glass preferably have a thickness of 0.5 to 10 mm, a diameter of 80 to 120 mm, and a center hole diameter of 10 to 15 mm. Typically, the transparent stampers A to D (19-A to 19-D) made of glass have a thickness of 1.0 mm, and a diameter and a center hole diameter, which are substantially the same as those of a PC substrate, of, for example, 120 mm and 15 mm, respectively. Further, it is assumed that in (2) of FIG. 3A, (6) of FIG. 3A, (10) of FIG. 3B, and (14) of FIG. 3C, an UV light source 5 irradiates light from the transparent stamper 19 side.

A four-layered optical recording medium was produced by following the same procedure as in Example 1 except for the above difference.

By employing the method of producing a multilayer optical recording medium according to the present invention, and by using the transparent stamper made of glass which can be repeatedly used, it becomes possible to supply four-layered optical recording media at low cost.

The respective distances between layers of the four-layered optical recording medium produced by the above-mentioned steps were as follows:
L0 layer-L1 layer: within a range of 10 μm±2 μm;
L1 layer-L2 layer: within a range of 15 μm±2.5 μm; and
L2 layer-L3 layer: within a range of 10 μm±2 μm.

### EXAMPLE 3

A method of producing a four-layered optical recording medium according to a third example of the present invention will be described with reference to FIGS. 3A to 3D. FIGS. 3A to 3D each show four layers of information recording surface, that is, an L0 layer, an L1 layer, an L2 layer, and an L3 layer. FIGS. 3A to 3D each show a cross-sectional view of a rotationally symmetric disk having a center hole, and the center hole of each of the substrate and the stamper is not shown. In FIGS. 3A to 3D, the elements which are the same as those shown in FIGS. 1A to 1D are identified by like numerals or symbols.

The third example is different from the first example of the present invention in that transparent stampers A to D (19-A to 19-D) made of glass are used instead of the stampers A to D (3, 8, 12, and 21). Incidentally, it is also preferable that the material of the stampers is made of transparent ceramics. A support substrate is a glass substrate. It is preferred that a transparent glass support substrate has a thickness of 0.2 to 2 mm, a diameter of 80 to 120 mm, and a center hole diameter of 10 to 30 mm. Typically, the transparent glass support substrate has a thickness of 1.2 mm, and a diameter and a center hole diameter, which are substantially the same as those of a PC substrate, of, for example, 120 mm and 15 mm, respectively. Further, the transparent stampers A to D (19-A to 19-D) made of glass each preferably have a thickness of 0.5 to 10 mm, a diameter of 80 to 120 mm, and a center hole diameter of 10 to 30 mm. Typically, the transparent stampers A to D (19-A to 19-D) made of glass each have a thickness of 1.0 mm, and a diameter and a center hole diameter, which are substantially the same as those of a PC substrate, of, for example, 120 mm and 15 mm, respectively. Further, it is assumed that in (2) of FIG. 3A, (6) of FIG. 3A, (10) of FIG. 3B, and (14) of FIG. 3C, an UV light source 5 irradiates light from the transparent stamper 19 side. The irradiation with the UV light source may be performed in any direction.

A four-layered optical recording medium was produced by following the same procedure as in Example 1 except for the above difference.

By employing the method of producing a multilayer optical recording medium according to the present invention, and by using the transparent stamper made of glass which can be repeatedly used, it becomes possible to supply four-layered optical recording media at low cost.

The respective distances between layers of the four-layered optical recording medium produced by the above-mentioned steps were as follows:
L0 layer-L1 layer: within a range of 10 μm±2 μm;
L1 layer-L2 layer: within a range of 15 μm±2.5 μm; and
L2 layer-L3 layer: within a range of 10 μm±2 μm.

### COMPARATIVE EXAMPLE 1

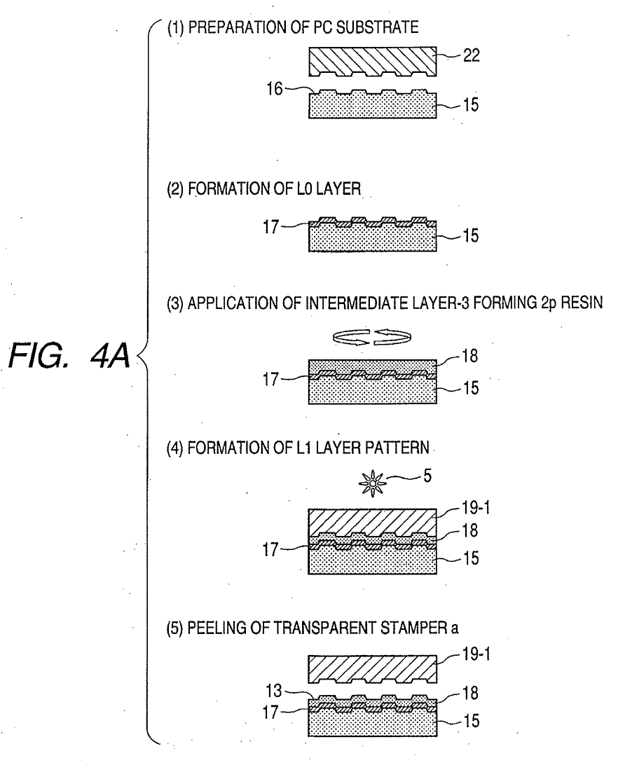

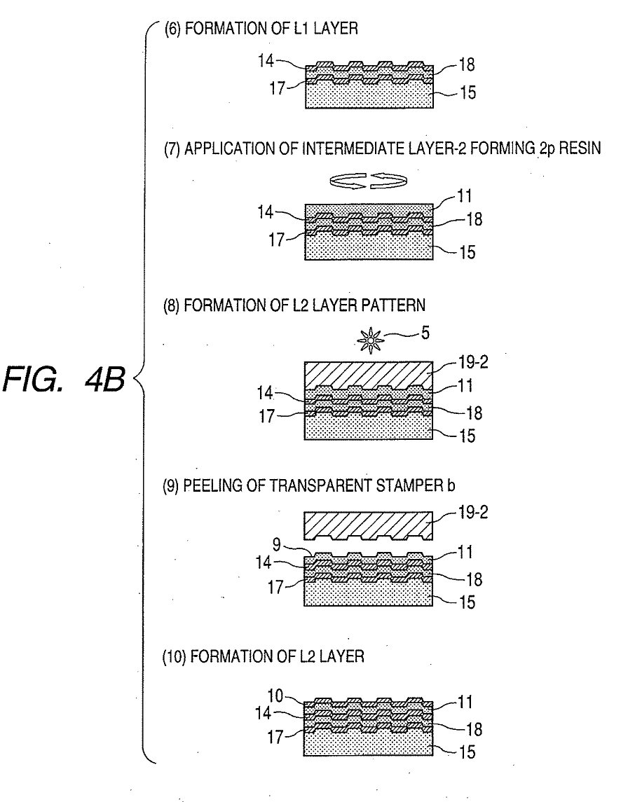

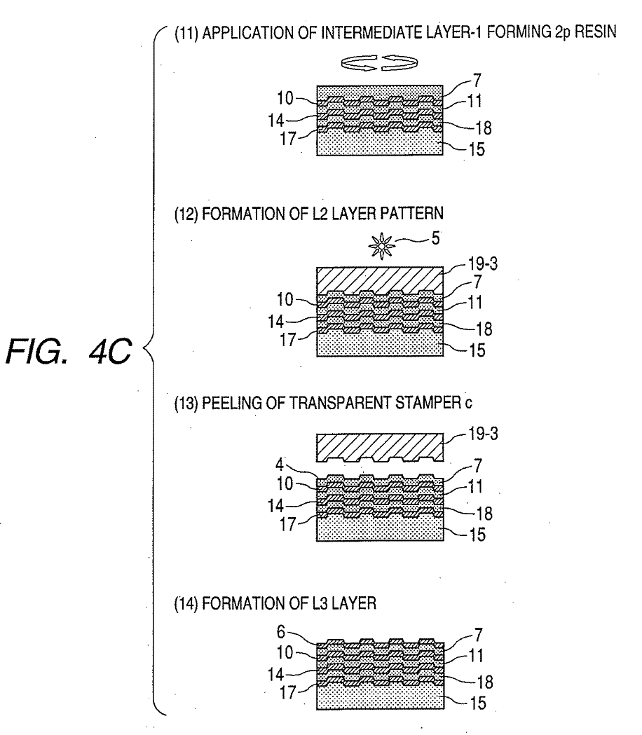

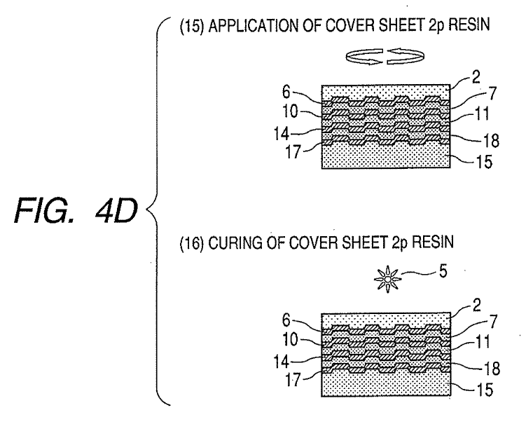

As a comparative example, a four-layered optical recording medium including four layers of information recording surface, that is, L0 to L3 layers was produced employing steps shown in FIGS. 4A to 4D. FIGS. 4A to 4D each show a cross-sectional view of a rotationally symmetric disk having a center hole, and the center hole of each of the substrate and the stamper is not shown.

In (1) of FIG. 4A, a PC substrate 15 was made of polycarbonate subjected to injection molding using a stamper 22 for injection molding, and pits or guide grooves each having a depth of about several tens of nm were formed on the PC substrate 15 as an information pattern 16 of an L0 layer. The PC substrate 15 had a thickness of 1.1 mm, a diameter of 120 mm, and a center hole diameter of 15 mm.

In (2) of FIG. 4A, an L0 layer recording film 17 was formed on the information pattern 16 for the L0 layer. The L0 layer recording film 17 included a reflective film which does not transmit light.

In (3) of FIG. 4A, an intermediate layer-3 forming 2p resin 18 for constituting an intermediate layer-3 between the L0 layer and an L1 layer provided on the L0 layer was applied to the L0 layer recording film 17. The thickness of the intermediate layer-3 forming 2p resin 18 was 10 μm.

In (4) of FIG. 4A, on the intermediate layer-3 forming 2p resin 18, a transparent stamper a 19-1 made of a resin having an information pattern for the L1 layer formed therein in advance was aligned using a center hole (not shown) and superposed thereon. After that, an ultraviolet ray from the UV light source 5 was irradiated thereon through the transparent stamper a 19-1 to cure the intermediate layer-3 forming 2p resin 18.

In (5) of FIG. 4A, after the intermediate layer-3 forming 2p resin 18 had been cured, when the transparent stamper a 19-1 was peeled off, pits or guide grooves each having a depth of about several tens of nm were formed on the PC substrate 15 as an information pattern 13 for the L1 layer. The thus peeled off transparent stamper a 19-1 was degraded due to the irradiation with the ultraviolet ray and could not be reused as a stamper, and in addition, application thereof was limited even when reused.

In (6) of FIG. 4B, an L1 layer recording film 14 was formed on the information pattern 13 for the L1 layer. The L1 layer recording film 14 was formed of a translucent film.

In (7) of FIG. 4B, an intermediate layer-2 forming 2p resin 11 for constituting an intermediate layer-2 between the L1 layer and an L2 layer was applied to the L1 layer recording film 14 in the same manner as described above. The intermediate layer-2 forming 2p resin 11 had a thickness of 15 μm.

In (8) of FIG. 4B, on the intermediate layer-2 forming 2p resin 11, a transparent stamper b 19-2 made of a resin having an information pattern for the L2 layer formed therein in advance was aligned using a center hole (not shown) and superposed thereon. After that, an ultraviolet ray from the UV light source 5 was irradiated thereon through the transparent stamper b 19-2 to cure the intermediate layer-2 forming 2p resin 11.

In (9) of FIG. 4B, after the intermediate layer-2 forming 2p resin 11 had been cured, when the transparent stamper b 19-2 was peeled off, pits or guide grooves each having a depth of about several tens of nm was formed on the PC substrate 15 as an information pattern 9 for the L2 layer. The thus peeled off transparent stamper b 19-2 was degraded due to the irradiation with an ultraviolet ray as was the case with the above and could not be reused as a stamper.

In (10) of FIG. 4B, on the information pattern 9 for the L2 layer, an L2 layer recording film 10 was formed. The L2 layer recording film 10 was formed of a translucent film as was the case with the above.

In (11) of FIG. 4C, an intermediate layer-1 forming 2p resin 7 for constituting the intermediate layer-1 between the L2 layer and an L3 layer was applied to the L2 layer recording film 10 in the same manner as described above. The intermediate layer-1 forming 2p resin 11 had a thickness of 10 μm.

In (12) of FIG. 4C, on the intermediate layer-1 forming 2p resin 7, a transparent stamper c 19-3 made of a resin having an information pattern for the L3 layer formed therein in advance was aligned using a center hole (not shown) and superposed thereon. After that, an ultraviolet ray from the UV light source 5 was irradiated thereon through the transparent stamper c 19-3 to cure the intermediate layer-1 forming 2p resin 7.

In (13) of FIG. 4C, after the intermediate layer-1 forming 2p resin 7 had been cured, when the transparent stamper c 19-3 was peeled off, pits or guide grooves each having a depth of about several tens of nm were formed on the PC substrate 15 as an information pattern 4 for the L3 layer. The thus peeled off transparent stamper c 19-3 was degraded due to the irradiation with the ultraviolet ray and could not be reused as a stamper.

In (14) of FIG. 4C, an L3 layer recording film 6 was formed on the information pattern 4 for the L3 layer. The L3 layer recording film 6 was formed of a translucent film.

In (15) of FIG. 4D, a cover sheet 2p resin 2 for constituting a cover sheet on the L3 layer recording film 6 was applied in the same manner as described above. The thickness of the cover sheet 2p resin 2 was 70 μm.

In (16) of FIG. 4D, an ultraviolet ray from the UV light source 5 was irradiated thereon to cure the cover sheet 2p resin 2. The distances between layers of the four-layered optical recording medium produced by the above-mentioned steps were:
L0 layer-L1 layer: within a range of 10 μm±2.5 μm;
L1 layer-L2 layer: within a range of 15 μm±4 μm; and
L2 layer-L3 layer: within a range of 10 μm±5 μm,
which adversely affected reading/writing of a signal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2006-020894, filed Jan. 30, 2006, and 2007-002336, filed Jan. 10, 2007, which are hereby incorporated by reference herein in their entirety.

What is claimed is:

1. A method of producing a multilayer optical recording medium which comprises n (an integer of 2 or more) recording layers on a base substrate, the method comprising the steps of:
(a) forming a resin layer with respect to a support substrate;
(b) disposing a stamper on the resin layer and irradiating a light beam thereto through the support substrate or the stamper to transfer an unevenness pattern of the stamper to the resin layer;
(c) forming a recording layer on the resin layer;
(d) repeating the steps (a) to (c) n times to stack n layers of resin layer with recording layer on the support substrate;
(e) bonding a base substrate to the n-th recording layer through an adhesive layer; and
(f) peeling off the support substrate.

2. The method according to claim 1, wherein at least one of the support substrate and the stamper transmits light beam.

3. The method according to claim 2, wherein the support substrate comprises glass or transparent ceramics as a main material, and the stamper comprises metal as a main material.

4. The method according to claim 2, wherein the support substrate comprises metal as a main material, and the stamper comprises glass or transparent ceramics as a main material.

5. The method according to claim 2, wherein the support substrate and the stamper each comprise glass or ceramics as a main material.
